(19) United States
(12) Patent Application Publication
(10) Pub. No.: US 2009/0287562 A1
(43) Pub. Date: Nov. 19, 2009

(54) ANONYMOUS MERCHANT-CUSTOMER LOYALTY REWARDS PROGRAM

(75) Inventors: Samuel H. Bosch, Portland, OR (US); Jonathan H. Bosch, Hillsboro, OR (US)

Correspondence Address: STOEL RIVES LLP - PDX, 900 SW FIFTH AVENUE, SUITE 2600, PORTLAND, OR, 97204-1268, US

(73) Assignee: Peregrin Technologies, Inc., Portland, OR (US)

(21) Appl. No.: 12/509,191

(22) Filed: Jul. 24, 2009

Related U.S. Application Data
(63) Continuation-in-part of application No. PCT/US09/32492, filed on Jan. 29, 2009.
(60) Provisional application No. 61/025,776, filed on Feb. 2, 2008.

(51) Int. Cl. G06Q 30/00; G06Q 40/00; G06K 5/00

(52) U.S. Cl. 705/14.27; 235/380

(57) ABSTRACT

A system of and method for rewarding an anonymous merchant-customer for performing multiple debit transactions on a defined set of merchant debit-machines comprises receiving data associated with a discrete one of the multiple debit transactions, generating and updating data associated with the anonymous customer without having the anonymous customer provide personally identifiable information, determining whether to reward the anonymous customer for performing one or more debit transactions, and if so, rewarding the anonymous customer. The method may be implemented on or by one or more merchant debit machines (e.g., automated teller machines (ATMs) and point-of-sale (POS) terminals), remote processors, financial institutions, general-purpose computers, or special-purpose computers.

### RELATED APPLICATIONS

This application is a continuation-in-part of and claims priority under 35 U.S.C. §§ 365(c) and 120 from International Application No. PCT/US09/32492, filed Jan. 29, 2009, which claims the benefit under 35 U.S.C. § 119(e) of U.S. Provisional Application No. 61/025,776, filed Feb. 2, 2008, all of which are hereby incorporated by reference in their entireties.

### BACKGROUND

The field of this disclosure relates to loyalty rewards programs and, more particularly, to rewarding an anonymous customer for performing debit transactions on a defined set of merchant debit machines, such as automated teller machines (ATMs) and point-of-sale (POS) terminals.

Loyalty programs help enhance brand loyalty by rewarding customers with incentives or other benefits for becoming or remaining a customer. Thus, loyalty programs are essentially structured marketing efforts that encourage loyal customer behavior. Well known loyalty programs include airline frequent-flyer programs, supermarket and retail frequent-buyer programs, gas station frequent-filler programs, and credit card cash-back and point-accrual programs. Customers must generally register and provide personally identifiable information, such as the customer's name, social security number, date of birth, address, phone number, and email address, in order to participate in a loyalty program (e.g., to accumulate, view, and redeem loyalty points). After registering, customer activity is monitored and information is gathered to help a merchant understand the customer's tastes, needs, and expectations. As a result, customers do not participate in the loyalty program based on one or more of the perceived lack of privacy after joining the loyalty program, the desire to avoid unsolicited sales calls, and the time it takes to complete the registration process. Thus, the present inventors have recognized a need for a loyalty program that rewards an anonymous customer.

### BRIEF DESCRIPTION OF THE DRAWINGS

FIG. 1 is a block diagram illustrating a loyalty reward system including card usage and reward modules, according to one embodiment.

FIG. 2 is a flow diagram illustrating a method of rewarding a customer, according to one embodiment.

FIG. 3 is a flow diagram illustrating an example process implemented by the card usage module of FIG. 1 to generate and update data associated with customers.

FIGS. 4A and 4B are diagrams illustrating various examples of card usage records.

FIG. 5 is a flow diagram illustrating an example process implemented by the reward module of FIG. 1 to reward a customer.

FIG. 6 is a block diagram illustrating operational components of a merchant debit machine, according to one embodiment.

FIG. 7 is a block diagram illustrating a system in which multiple merchant debit machines access card usage records stored on a common storage device, according to one embodiment.

FIG. 8 is a block diagram of a system in which a remote processor implements a customer loyalty reward program, according to one embodiment.

FIG. 9 is a block diagram of a system in which one or more financial institutions implement a customer loyalty reward program, according to one embodiment.

### DETAILED DESCRIPTION

With reference to the above-listed drawings, this section describes particular embodiments and their detailed construction and operation. The embodiments described herein are set forth by way of illustration only. In light of the teachings herein, those skilled in the art will recognize that there may be equivalents to what is expressly or inherently taught herein. For example, variations can be made to the embodiments described herein and other embodiments are possible. It is not always practical to exhaustively catalog all possible embodiments and all possible variations of the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

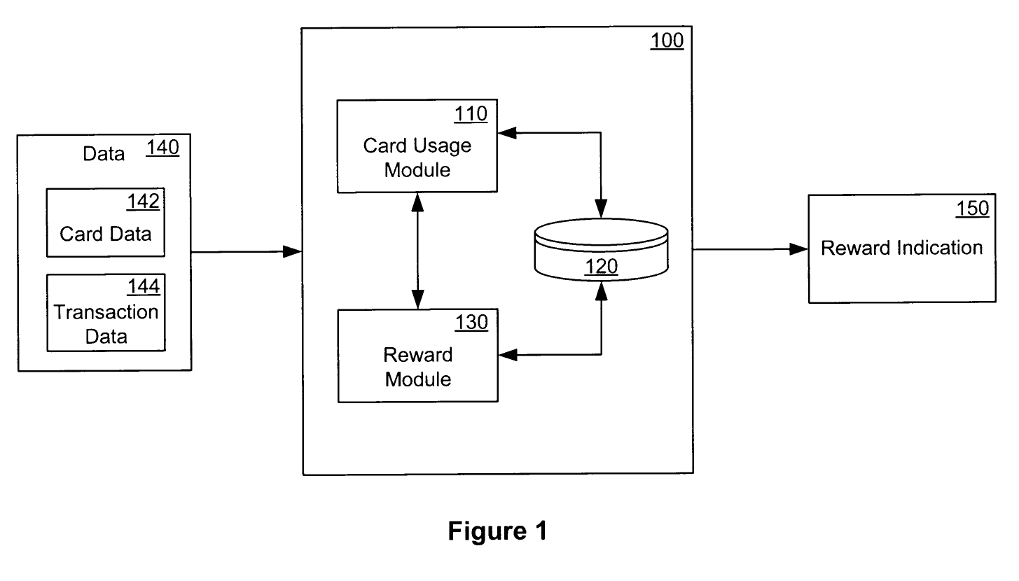

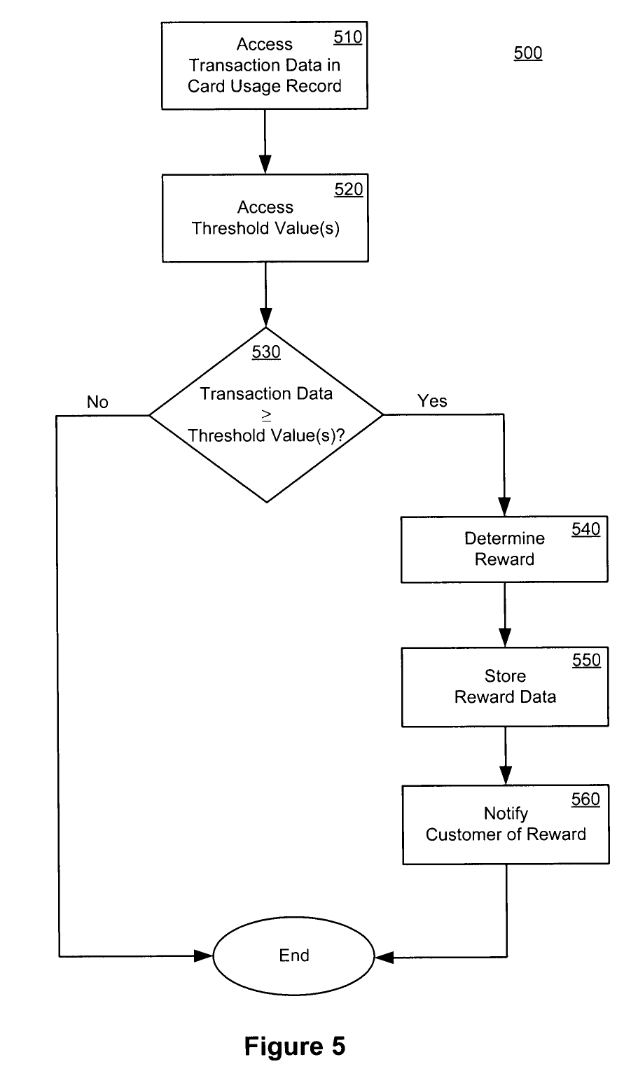

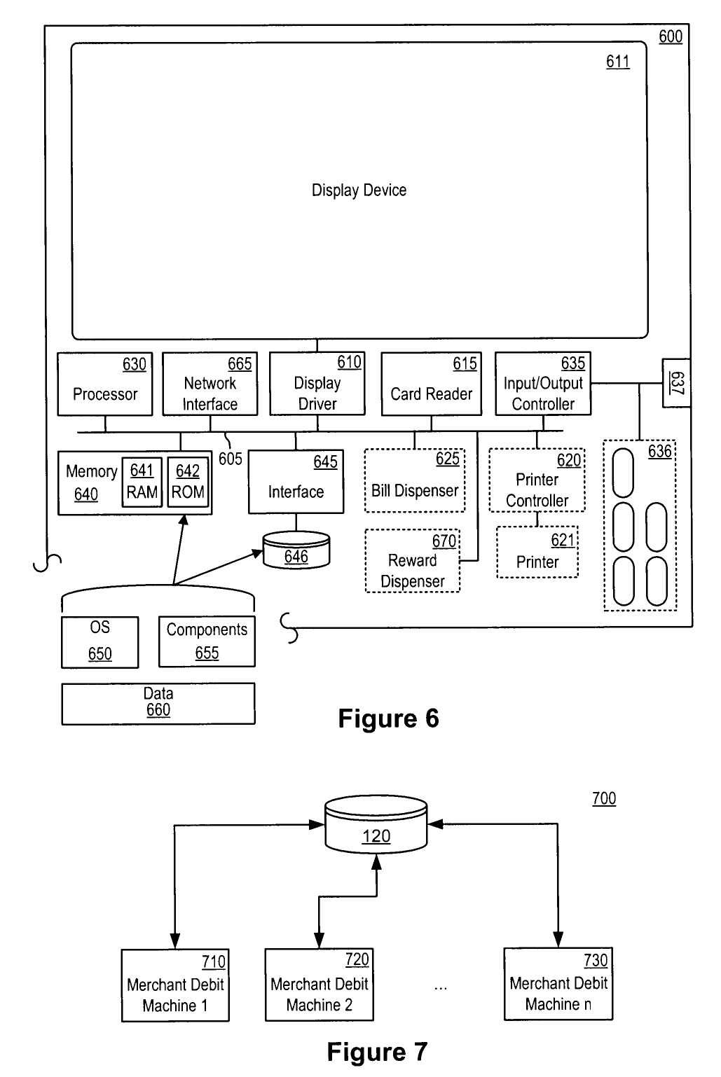

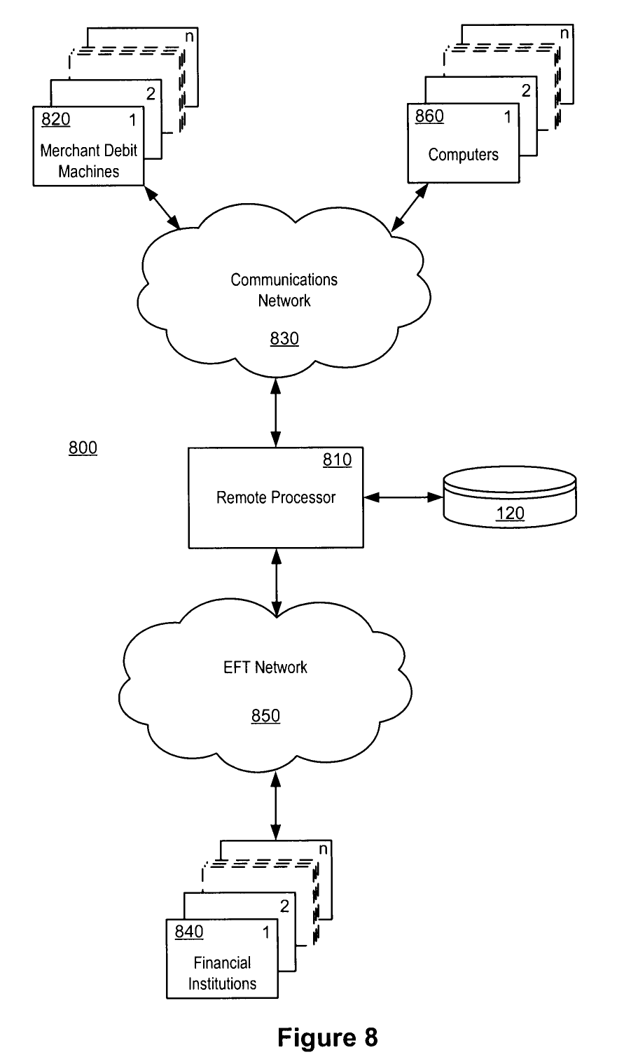

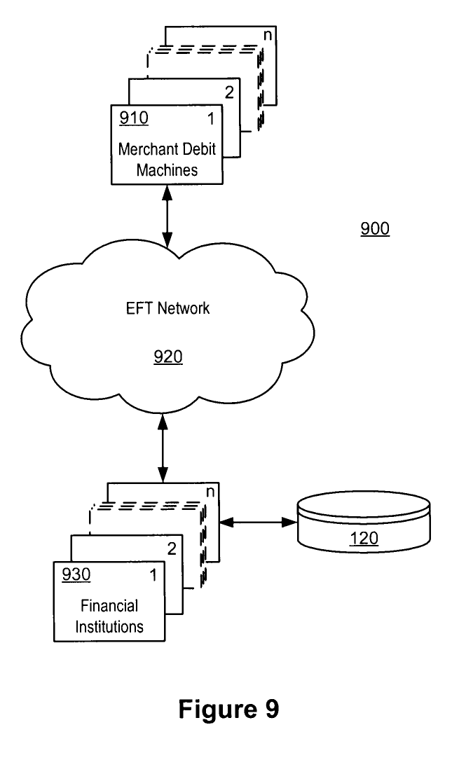

FIG. 1 is a block diagram illustrating a loyalty reward system 100 for rewarding a customer, such as a merchant customer, for performing one or more debit transactions, according to one embodiment. The loyalty reward system 100 includes a card usage module 110 for generating and updating data associated with customers, a memory 120 for storing the data associated with the customers, and a reward module 130 for determining whether to reward a customer for performing one or more debit transactions on a defined set of merchant debit machines. As used herein, a component or module may comprise hardware, software, firmware, or any combination thereof (e.g., self-contained hardware or software components that interact with a larger system). While the system 100 illustrates particular modules for the sake of illustration, in other embodiments, one or more of the illustrated modules may be merged, divided into additional modules, or omitted. The components illustrated in FIG. 1, as well as the functions of those components, may be implemented in one or more merchant debit machines (see, e.g., FIGS. 6 and 7), one or more remote processors (see, e.g., FIG. 8), one or more financial institutions (see, e.g., FIG. 9), a combination of one or more merchant debit machines, remote processors, and financial institutions, or a general-purpose or special-purpose computing environment.

The loyalty reward system 100 accepts as an input, data 140, such as card data 142 and transaction data 144, and outputs a reward indication 150 if certain criterion are met, such as if the customer performs a minimum number of debit transactions or withdraws a minimum aggregate transaction amount within a predetermined period of time. For example, a merchant debit machine, such as an ATM terminal or POS terminal, reads from a card, such as an ATM card or debit card, card data 142 as the customer swipes the card at the merchant debit machine. After the customer enters transaction data 144, such as a transaction dollar amount, using the merchant debit machine and the merchant debit machine (or remote processor) determines that the customer is authorized to perform the transaction, the card usage module 110 determines whether the card has previously been used on the merchant debit machine (or on a merchant debit machine located at another merchant site if the merchant has multiple sites). For example, the card usage module 110 may determine whether the memory 120 has stored thereon a card usage record corresponding to the card data 142.

If the customer's card has not previously been used on the merchant debit machine, the card usage module 110 stores all or a portion of the card data 142 and the transaction data 144 in the memory 120. If, on the other hand, the customer's card has previously been used on the merchant debit machine, the card usage module 110 updates the data associated with the card data 142 to reflect the additional transaction performed using the card. The reward module 130 monitors the transaction data associated with each card stored in the memory 120 to determine whether to offer a reward or prize to the customer. For example, the merchant may program the reward module 130 to offer a reward to a customer if the customer performs ten debit transactions or withdraws $1,000 within a 180 day period. If the customer performs ten debit transactions or withdraws $1,000 within the 180 day period, the loyalty reward system 100 presents the reward indication 150 to the customer (e.g., prints on a receipt, displays on a screen of the merchant debit machine, or both, an indication that the customer has received a T-shirt for using the merchant debit machine along with instructions that the T-shirt can be collected from a merchant clerk). The reward is preferably selected by the merchant and preferably comprises one or more goods or services offered for sale by the merchant. Thus, the customer is rewarded without having to register for the reward program and without having to provide personally identifiable information. The customer does not provide personally identifiable information when the customer first participates in the loyalty reward program, the customer does not provide personally identifiable information while the customer participates in the loyalty reward program (e.g., performs transactions on certain merchant debit machines), and the customer does not provide personally identifiable information when the customer receives a reward. In other words, the customer remains anonymous while participating in the loyalty rewards program (e.g., the merchant does not know the identity of the customers that are participating in the loyalty rewards program).

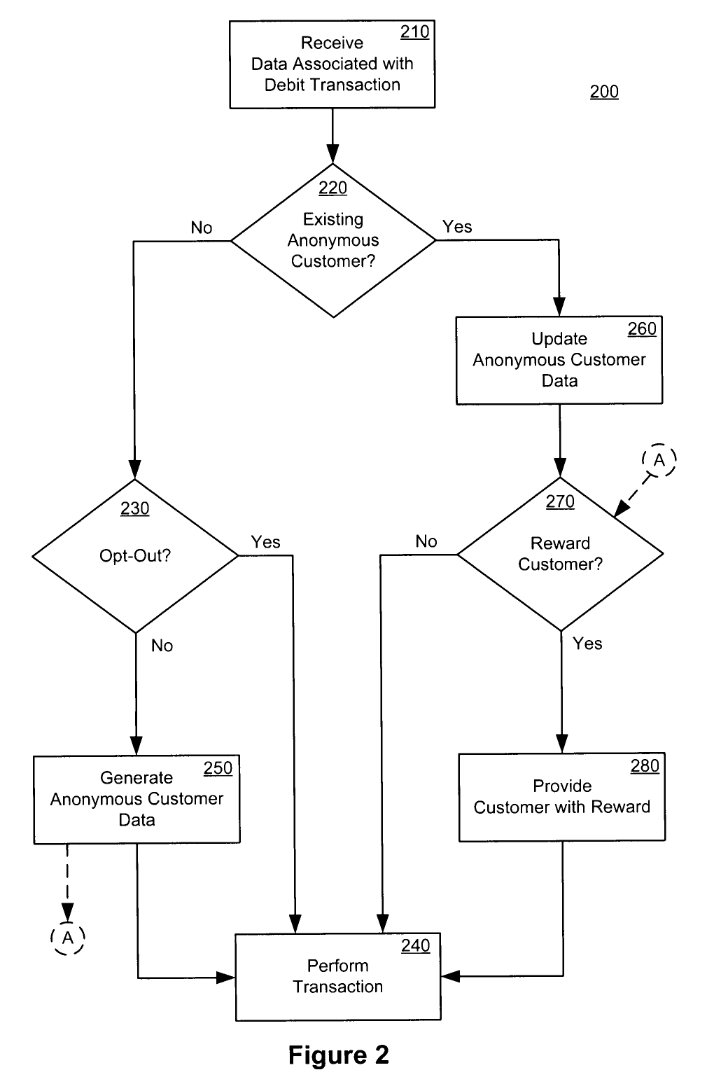

FIG. 2 is a flow diagram illustrating an example method 200 of rewarding a customer for performing one or more debit transactions on a defined set of merchant debit machines. The defined set may include a single merchant debit machine (e.g., installed at one merchant location) or may include multiple merchant debit machines (e.g., installed at various merchant locations, such as a chain of convenience stores). At step 210, one of the merchant debit machines receives data associated with a debit transaction. A debit transaction includes any transaction related to a deposit account associated with a customer, such as a checking account or savings account. Thus, a debit transaction may include a transaction that withdraws money from a deposit account, deposits money into a deposit account, makes a payment from a deposit account, transfers money from one deposit account to another, or checks a balance of a deposit account.

The data received by the merchant debit machine preferably includes card data and transaction data. The card data includes any data that allows the customer to access a deposit account. For example, the card data may include data printed on a card (e.g., an ATM card or debit card), data encoded or stored on a card (e.g., a major industry identifier (MII), issuer identifier number (IIN), bank identifier number (BIN), account number, card number, and checksum digit), and data input by the customer, such as an account number, card number, personal identification number (PIN), or any other number, letter, character, or symbol associated with the deposit account and which allows the customer to perform a transaction with the deposit account. The transaction data includes any data associated with the transaction, such as a transaction amount, terminal identification number, merchant location, and transaction date and time, and may be input by the customer (e.g., via a keypad of the merchant debit machine) or supplied by another device, such as an electronic cash register or computer.

The data received at step 210 may be received in any number of ways. For example, if the merchant debit machine comprises an ATM terminal, the ATM terminal prompts the customer to enter an account number (e.g., swipe or insert an ATM card or debit card) and enter a PIN. After the customer enters an account number and PIN (e.g., via a keypad), the ATM terminal authenticates the customer. For example, the ATM terminal may query a database (locally or on a network) having stored therein account numbers along with associated PINs. If the account number entered by the customer matches an account number stored in the database and the PIN entered by the customer matches a PIN associated with the account number in the database, the ATM terminal prompts the customer to engage in a transaction and enter transaction data (e.g., make a withdrawal, check account balance, or make a deposit). After the customer enters the transaction data, the ATM terminal determines whether the customer is authorized to perform the transaction. For example, if the customer requests to make a withdrawal, the ATM terminal may query a database having stored therein account numbers along with associated account balances. If the requested withdrawal amount (e.g., $100) is less than or equal to the account balance associated with the account number, the request to make a withdrawal is authorized and the ATM terminal proceeds to step 220.

By way of another example, if the merchant debit machine comprises a POS terminal, the merchant enters the transaction data and the POS terminal prompts the customer to enter an account number (e.g., swipe or insert an ATM card or debit card) and a PIN. In certain embodiments, the customer need not enter a PIN because certain authentication processes rely on a signature in lieu of a PIN to authenticate the transaction (e.g., the customer signs a transaction slip instead of entering a PIN). Additionally, in certain embodiments, the POS terminal prompts the customer to enter a cash back amount (e.g., an amount of cash the customer would like to receive in addition to the purchase). After the merchant enters the transaction data and the customer enters an account number and PIN, the POS terminal authenticates the customer and determines whether the customer is authorized to perform the transaction. If so, the POS terminal proceeds to step 220. According to a preferred embodiment, if a transaction is not performed (e.g., the transaction is denied or the transaction is terminated before completion), steps 220 through 280 are not performed (i.e., the method 200 does not reward the customer for transactions that are not performed).

At step 220, the method 200 determines whether the customer has previously performed a transaction using the merchant debit machine or a related merchant debit machine. For example, if a merchant wants to reward a customer for performing transactions on a particular merchant debit machine (e.g., a merchant debit machine located at a particular merchant location), the merchant debit machine may check whether the customer has previously performed a transaction using that particular merchant debit machine (e.g., by searching for data associated with the customer on a local memory, such as card data). By way of another example, if a merchant has multiple merchant debit machines (e.g., merchant debit machines located at various merchant locations) and the merchant wants to reward a customer for performing transactions on any of the multiple merchant debit machines, the merchant debit machine may check whether the customer has previously performed a transaction using any one of the multiple merchant debit machines (e.g., by searching for data associated with the customer on each of the multiple merchant debit machines or a memory accessible by each of the multiple merchant debit machines). Thus, step 220 may be performed by one or more merchant debit machines, remote processors, financial institutions, general-purpose or special-purpose computers, or any combination thereof.

If the customer has not previously performed a transaction using the merchant debit machine or a related merchant debit machine, the customer is optionally given the option to opt-out of the reward program at step 230. According to one embodiment, the customer is not given the option to opt-out and the method 200 proceeds to step 250 from step 220. If the customer opts out, the transaction is performed at step 240 and a receipt recording the transaction may optionally be printed. The actions performed at step 240 depend on the transaction performed. For example, if the customer requested a withdrawal, the currency is dispensed at step 240. By way of another example, if the customer is making a deposit, the currency being deposited is accepted by the merchant debit machine. By way of yet another example, if the customer is transferring money between accounts or making a payment, the transaction amount is debited from the customer's account and credited to the appropriate account.

If the customer does not opt out, data associated with the transaction that the customer performed is generated at step 250 and the transaction is performed at step 240 (and a receipt may also optionally be printed). For example, all or a portion of the card data (e.g., a portion of a card number or account number), a date and time of the transaction, and a transaction amount are recorded in a new file. Assuming the customer does not opt-out or is not given the option to opt-out, the customer is automatically entered into the reward program at step 250. In other words, the customer does not need to register and provide personally identifiable information (e.g., the customer's name, social security number, date of birth, street address, phone number, email address, driver's license number, picture, fingerprints, signature, handwriting sample, or voice sample) in order to participate in the rewards program. According to an alternative embodiment, the method proceeds to step 270 after step 250 (see dashed line in FIG. 2).

Referring again to step 220, if the customer has previously performed a transaction using the merchant debit machine or a related merchant debit machine, the data associated with the customer is updated at step 260. For example, a date and time of the transaction and a transaction amount are added to the file associated with the customer. After the data associated with the customer is updated at step 260, the method proceeds to step 270 where the method 200 determines whether to reward the customer. For example, the customer may be offered a reward if the number of transactions performed by the customer meets or exceeds a minimum number transactions, the aggregated transaction amount (e.g., a total amount in dollars) meets or exceeds a minimum aggregated transaction amount, or both. If it is determined to not reward the customer, the method 200 proceeds to step 240 and the transaction is performed (and a receipt may also optionally be printed). On the other hand, if it is determined to reward the customer, the customer is provided a reward at step 280 and the transaction is performed at step 240 (and a receipt may also optionally be printed). The customer may be provided with a reward at step 280 in a number of ways, such as printing on a receipt, displaying on a screen associated with the merchant debit machine, or both, an indication that the customer has won a reward, an indication of the award the customer has won, and instructions that the reward may be collected from a merchant clerk.

Thus, the method 200 rewards the customer without having the customer register for the reward program and without having the customer provide personally identifiable information. While the method 200 has stored card data and transaction data (e.g., all or a portion of a card number or account number and transactions performed using the card number or account number), the customer cannot be identified based on the stored card data and transaction data unless certain hurdles are overcome, such as asking a card issuer for personal information associated with the card data. The possibility of obtaining personal information based on the card data can be further mitigated by recording only a portion of the card number or a portion of an account number.

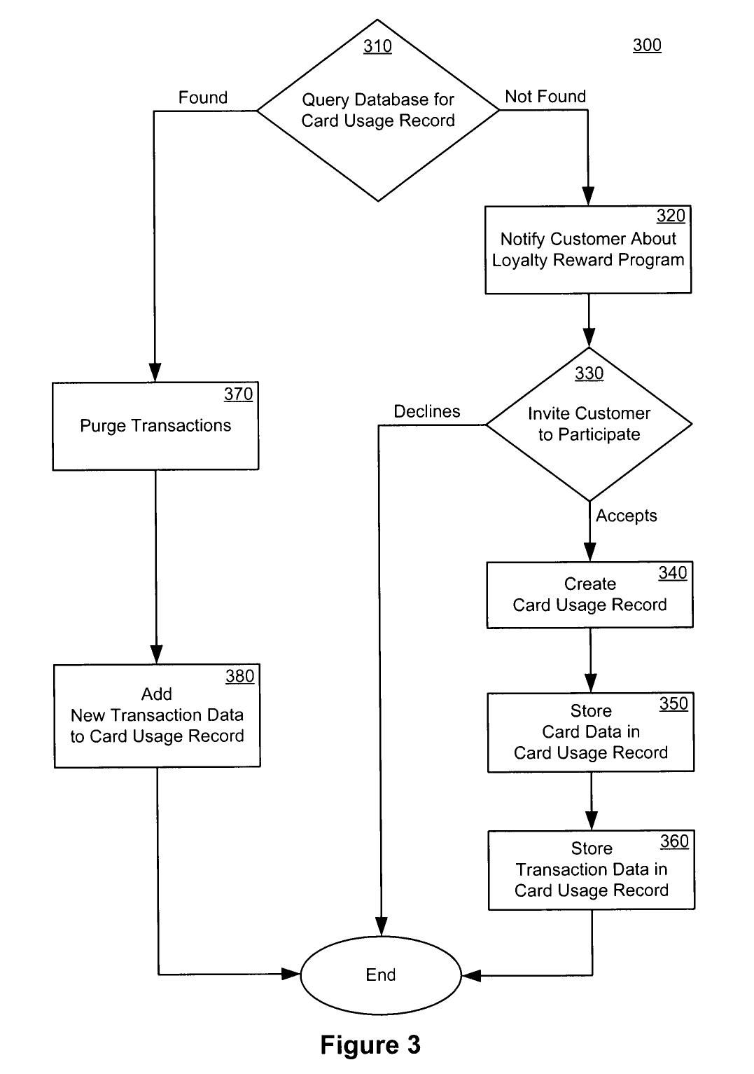

FIG. 3 is a flow diagram illustrating a method 300 which may be implemented by the card usage module 110 to generate and update data associated with customers. After data, such as card data and transaction data, associated with a transaction is received, the card usage module 110 determines, at step 310, whether a card usage record corresponding to the card data is stored in a memory. The memory may be a local memory (e.g., installed on or connected to a merchant debit machine) or may be a remote memory (e.g., accessible over a communications link or network). According to a preferred embodiment, the memory has stored thereon a database including one or more card usage records that store card data associated with each card used to perform a transaction on a merchant debit machine and transaction data associated with each transaction performed using the card. Thus, after receiving card data associated with a transaction, the card usage module 110 may query the database, at step 310, to determine whether the database includes a card usage record corresponding to the card data. In other words, the card usage module 110 determines, at step 310, whether the card data has previously been used to perform a transaction using the merchant debit machine.

If a card usage record corresponding to the card data is not found (e.g., the card data has not previously been used to perform a transaction using the merchant debit machine), the card usage module 110 notifies the customer about the loyalty reward program at step 320. For example, the card usage module 110 may cause a display of the merchant debit machine to present to the customer a message indicating that the customer is eligible to participate in a loyalty rewards program that will provide the customer with a reward (e.g., a product or service provided by the merchant) for using the merchant debit machine or a group of merchant debit machines. Step 320 may be omitted in certain embodiments.

After notifying the customer about the loyalty reward program at step 320, the card usage module 110 invites the customer to participate in the rewards program at step 330. For example, the card usage module 110 may cause a display of the merchant debit machine to present to the customer a prompt requesting the customer to accept or decline an invitation to participate in a loyalty reward program and the customer may respond to the prompt using an input device associated with the merchant debit machine. If the customer declines the invitation to participate in the loyalty reward program, the customer is not entered into the loyalty reward program (e.g., a card usage record corresponding to the card data is not generated) and the method 300 ends. After the method 300 ends, the transaction is performed as described with reference to FIGS. 1 and 2 and a receipt may optionally be printed. If the customer accepts the invitation to participate in the loyalty reward program, the card usage module 110 creates, at step 340, a card usage record corresponding to the card data. According to one embodiment, the customer is automatically entered into the loyalty rewards program (e.g., the customer is not given an option to participate in the loyalty rewards program) and the method 300 proceeds to step 340 from step 320.

At step 340, the card usage module 110 creates a card usage record corresponding to the card data. The card usage record comprises a collection of information, preferably preserved in machine-readable form, regarding the use of a card on one or more merchant debit machines. The card usage record preferably includes card data and transaction data, but not personally identifiable information associated with the customer (i.e., the customer remains anonymous). A plurality of card usage records (each of which corresponds to a different card) may be organized according to various database models, such as a relational database model, hierarchical database model, or network database model. For example, the card usage data may be organized in a table that has rows representing individual entries or records (of variable or fixed length) in the database and columns or fields that define what is stored in each entry or record.

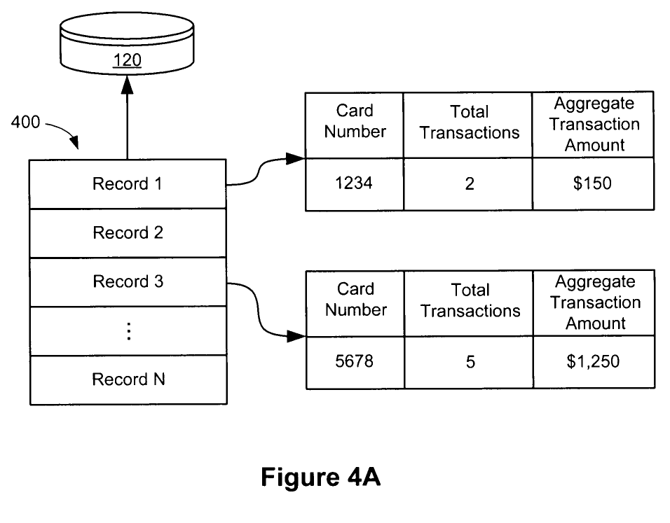

FIG. 4A illustrates a database table 400 stored in memory 120. The database table 400 includes a plurality of card usage records (labeled records 1 through N). Card usage records 1 and 3 are shown in more detail on the right-hand-side of the table 400 to include a card-number field for storing all or a portion of the card data, a total-number-of-transactions field for storing a total number of transactions performed using the card data, and an aggregate-transaction-amount field for storing an aggregate transaction amount for transactions performed using the card data. The card usage records may include additional fields or omit certain fields. For example, card usage record 1 indicates that card number 1234 (which may be a portion of a card number, such as the first four or five digits and last four or five digits) has been used on the merchant debit machine two times to perform transactions totaling $150 and card usage record 3 indicates that card number 5678 has been used on the merchant debit machine five times to perform transactions totaling $1,250.

Referring again to FIG. 3, the card usage module 110 creates, at step 340, a card usage record corresponding to the card data. For example, the card usage module 110 may store in a database table a card usage record including a card-number field, a total-number-of-transactions field, and an aggregate-transaction-amount field. The fields may have values set to an initial value of zero. At step 350, the card usage module 110 stores all or a portion of the card data in the card usage record. For example, the card usage module 110 may store all or a portion of the card number in the card-number field. At step 360, the card usage module 110 stores all or a portion of the transaction data in the card usage record. For example, the card usage module 110 may increment by one the value stored in the total-number-of-transactions field (or store a value of one in the field) and add the transaction amount to the value stored in the aggregate-transaction-amount field (or store the transaction amount in the field).

According to another embodiment, the card usage module 110 creates a transaction record corresponding to each transaction performed using a card and a card usage record that pulls or aggregates data from the transaction records. For example, FIG. 4B illustrates a card usage record 410 and transaction records 420 and 430, all of which are stored in memory 120. The memory 120 may include additional card usage records corresponding to different cards. According to one embodiment, the card usage records are stored in the memory 120 in a master card usage file and the transaction records are stored in the memory 120 in a transaction file. The transaction records 420 and 430 include a card-number field, a date field for storing the date of the transaction, a time field for storing the time of the transaction, and amount field for storing the amount of the transaction. For example, transaction record 420 indicates that card number 1234 was used on Jan. 1, 2007 at 2:00 PM to perform a $100 transaction and transaction record 430 indicates that card number 1234 was used on Mar. 5, 2007 at 8:00 AM to perform a $50 transaction. The transaction records may omit certain fields or include additional fields, such as a terminal-ID field for storing an indication of which merchant debit machine was used to perform the transaction and a transaction-type field for storing an indication of the type of transaction performed (e.g., a withdrawal, deposit, and payment at a POS terminal).

The card usage record 410 includes a card-number field, a last-used field for storing the date of the last transaction performed using the card, a total-number-of-transactions field, and an aggregate-transaction-amount field. The card usage record 410 may include additional fields or omit certain fields. The total-number-of-transactions field contains variable data that reflects the total number of transactions performed using the card number associated with the card usage record. For example, if memory 120 contains two transaction records associated with card number 1234, the total-number-of-transactions field reflects that two transactions have been performed using card number 1234. The aggregate-transaction-amount field contains variable data that reflects an aggregate transaction amount for transactions performed using the card number associated with the card usage record. For example, aggregate-transaction-amount field reflects an aggregate transaction amount of $150 because memory 120 contains transaction records 420 and 430, which include transactions amounts of $100 and $50, respectively.

Referring again to FIG. 3, after the card usage module 110 creates, at step 340, a card usage record corresponding to the card data, stores, at step 350, all or a portion of the card data in the card usage record, and stores, at step 360, all or a portion of the transaction data in the card usage record, the method 300 ends. In certain embodiments, steps 340, 350, and 360 may be performed in a different order or at the same time and one or more of steps 340, 350, and 360 may be omitted.

If, at step 310, a card usage record corresponding to the card data is found (e.g., the card data has previously been used to perform a transaction using the merchant debit machine), the card usage module 110 may purge transaction data corresponding to one or more transactions at step 370. For example, the card usage module 110 may remove from the card usage record transaction data associated with transactions performed before a predetermined date (the predetermined date may be set by the merchant). In other words, certain transactions may expire (e.g., no longer count toward a reward) after a configurable period of time, such three to twelve months. According to one embodiment, step 370 is omitted.

At step 380, the card usage module 110 adds the new transaction data to the card usage record. For example, the card usage module 110 may increment by one the value stored in the total-number-of-transactions field and add the transaction amount to the value stored in the aggregate-transaction-amount field. By way of another example, the card usage module 110 creates a transaction record corresponding to the new transaction and causes the card usage record to update the variable data in the last-used field, total-number-of-transactions field, and aggregate-transaction-amount field to reflect the data in the new transaction record. After the card usage module 110 adds the new transaction data to the card usage record, the method 300 ends. After the method 300 ends, the reward module 130 is called to determine whether to reward a customer, the transaction is performed as described with reference to FIGS. 1 and 2, or both.

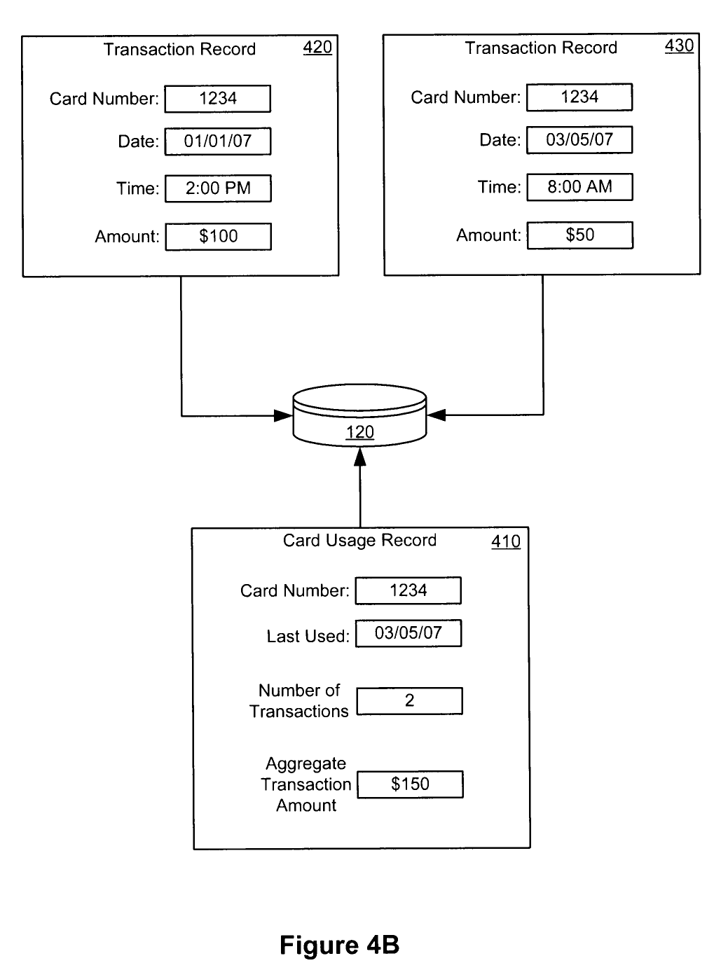

FIG. 5 is a flow diagram illustrating a method 500 which may be implemented by the reward module 130 to determine whether to reward a customer for performing transactions on one or more merchant debit machines. According to one embodiment, the method 500 is performed after one or more of steps 360 and 380 of FIG. 3. After being called, the reward module 130 accesses, at step 510, transaction data stored in a card usage record, accesses, at step 520, one or more threshold values, and determines, at step 530, whether the transaction data is equal to or greater than the one or more threshold values. For example, after a merchant debit machine receives card data and transaction data associated with a discrete transaction and the card usage module 110 generates or updates a card usage record associated with card data to reflect the transaction data, the reward module 130 determines whether the card usage record has stored therein transaction data that meets or exceeds a predetermined threshold value, such as a minimum number of transactions or minimum aggregated transaction amount. According to a preferred embodiment, the one or more threshold values are selected or set by the merchant and are stored in the same memory as the card usage records.

If the reward module 130 determines that the transaction data does not meet or exceed one or more threshold values, the customer is not rewarded and the method 500 ends. After the method 500 ends, the transaction is performed as described with reference to FIGS. 1 and 2 and a receipt may optionally be printed. If, on the other hand, the reward module 130 determines that the transaction data does meet or exceed one or more threshold values, the reward module 130 determines a reward to offer the customer at step 540. For example, the reward module 130 may access data in memory 120 indicating the reward to offer the customer if one or more of the threshold values are met or exceeded. The reward is preferably selected by the merchant and may vary based on a number of conditions, such as the number of threshold values met or exceeded (e.g., whether a minimum number of transactions, a minimum aggregate transaction amount, or both, were met or exceeded), the extent to which the threshold value(s) were exceeded, or the type of transactions that were performed (e.g., the merchant may choose to provide a better reward if the customer performs transactions that generate more revenue for the merchant).

After determining the reward to offer the customer, the reward module 130 stores reward data at step 550. For example, the reward module may store in memory 120 an indication of the reward offered to the customer so that the merchant can review which merchant debit machines tend to reward customers and the nature of the rewards being offered.

At step 560, the reward module 130 notifies the customer of the reward. For example, the reward module may cause to be printed on a receipt an indication that the customer has won a reward, an indication of the award the customer has won, and instructions that the reward may be collected from a merchant clerk (e.g., the customer may take the receipt to a merchant clerk at a checkout stand to collect the reward). By way of another example, the reward module may cause a display associated with the merchant debit machine to provide to the customer an indication that the customer has won a reward along with an indication of the award the customer has won. By way of yet another example, the reward module causes the indication to be printed and displayed. By way of still another example, the merchant debit machine may dispense the reward (e.g., via a bill dispenser if the reward is cash, via a printer if the reward is a voucher for a good or service, or via a reward dispenser if the merchant debit machine is so equipped). If the merchant debit machine is not configured to print customized receipts or display customized messages, another device may print, display, or dispense the reward.

In certain embodiments, the merchant clerk is notified that the customer has received a reward. For example, a printer or display proximate the merchant clerk may provide the clerk with an indication that a customer has received a reward, an indication of the reward, and possibly a unique code that matches a code printed on a receipt received the customer. If the merchant debit machine is located proximate the merchant clerk (e.g., a POS terminal), the clerk may be notified along with the customer. Thus, the clerk may present the reward to the customer without first being asked by the customer.

According to a preferred embodiment, after the customer is provided with a reward, the reward module 130 purges one or more transactions from the card usage record or provides the card usage module 110 with instructions to purge one or more transactions from the card usage record to start a new reward-period. For example, the value stored in the total-number-of-transactions field and the value stored in the aggregate-transaction-amount field may be set to zero. By way of another example, one or more of the transaction records may be deleted, such as the most recent transaction record or the transaction records that caused the card usage record to meet or exceed the threshold value.

After the customer is notified of the reward at step 560, the method 500 ends and the transaction is performed as described with reference to FIGS. 1 and 2. In certain embodiments, steps 540, 550, and 560 may be performed in a different order or at the same time and one or more of steps 540, 550, and 560 may be omitted.

FIG. 6 is a functional block diagram of one illustrative architecture of a merchant debit machine 600 in which the described embodiments may be implemented. In FIG. 6, a bus-based architecture is illustrated, based on a bus 605. Other types of architectures are also suitable, such a direct connection between one or more of the components. A number of components interface to the bus 605, including one or more of a display driver 610, a card reader 615, a printer controller 620, a bill dispenser 625, a processor 630, an input/output controller 635, a memory 640, a memory interface 645, a network interface 665, and a reward dispenser 670. Other versions of the merchant debit machine 600 may omit one or more of these components, may contain additional components, or both. Thus, the merchant debit machine 600 may comprise an ATM, POS terminal, debit POS terminal, cash register, general-purpose computer, or special-purpose computer. For example, if the merchant debit machine 600 comprises an ATM, the reward dispenser 670 may be omitted. By way of another example, if the merchant debit machine 600 comprises a POS terminal, the bill dispenser 625 and the reward dispenser 670 may be omitted.

Display driver 610 interfaces with processor 630 and a display 611 to present, for example, in textual form, graphical form, or both, data or other information stored in one or more of memories 640 and 646. For example, the merchant debit machine 600 may present data, menus, prompts (e.g., a prompt requesting whether a customer would like to opt-out of the loyalty reward program, a prompt requesting from a merchant user a submission of a predetermined threshold value, and a prompt requesting from a merchant user a submission of a reward to provide the customer), indications (e.g., an indication of a reward a customer has received), and otherwise communicate with the user via one or more display devices 611. Display 611 may comprise any display device, such as an integrated cathode ray tube (CRT), liquid crystal display (LCD), or other display device.

A customer may use any access control device or method to perform a debit transaction using the merchant debit machine 600. For example, the customer may key in access information or card data 142 (e.g., one or more of a card number, account number, and PIN) using an input device 636 or use a card reader 615 to read from a card, such as an ATM card, debit card, prepaid card, or smart card, card data 142. An ATM card may be used at an ATM or POS terminal along with a PIN to perform a transaction (e.g., withdraw cash or make a purchase). Likewise, a debit card may be used at an ATM or POS terminal along with a PIN to perform a transaction (e.g., a pin-based debit card) and may also be used at a POS terminal without the use of a PIN (e.g., the customer's signature is used in lieu of a PIN for authentication). A smart card includes an embedded processor and memory that stores information, such as card data 142. Thus, the merchant debit machine 600 may include one or more card readers 615, such as a magnetic card reader, a smart card reader, and a barcode reader, that reads data from a card and transmits the data to the processor 630. The one or more card readers 615 may also write data to a card. One or more of the card readers 615 may be integrated into the merchant debit machine 600 or may be coupled to the merchant debit machine 600 via the input/output controller 635 and connector 637.

A magnetic card reader/writer is a known device that reads information from a strip of magnetic material affixed to a card, writes information to the magnetic strip, or both. A smart card reader/writer is a device designed to read information from a smart card and to write information back to the smart card. A barcode reader or optical code reader is a device used to read barcodes, optical codes, or other symbols or information imprinted on various surfaces in order to transmit the information encoded in the optical code or symbol to the processor 630. Two types of commonly used optical code readers are flying spot scanners and imaging based scanners.

The merchant debit machine 600 may also include printer controller 620 to interface with a printer 621 (e.g., via a bi-direction port, such as a IEEE 1284 parallel port, a RS232 port, a USB port, or a wired or wireless network connection). The printer 621 may be used to print receipts for the customers, an indication of a reward being offered to the customer, summary reports for merchants (e.g., data associated with the use merchant debit machine 600 and rewards offered to customers), or coupons.

A bill dispenser 625 or coin dispenser may be provided to dispense currency to the customer. According to one embodiment, the bill dispenser 625 includes a currency source or safe, a dispensing aperture from which the currency is dispensed, and a conveyor or routing system for transporting currency from the currency source to the dispensing aperture. The bill dispenser 625 is operable to selectively dispense one or more denominations of currency in response to one or more instructions from the processor 630.

The processor 630 may be any form of processor and is preferably a digital processor, such as a general-purpose microprocessor or a digital signal processor (DSP), for example. The processor 630 may be readily programmable, hard-wired (e.g., an application specific integrated circuit (ASIC)), or programmable under special circumstances (e.g., a programmable logic array (PLA) or field programmable gate array (FPGA)). Program memory for the processor 630 may be integrated within the processor 630, may be part of the memory 640 or 646, or may be an external memory.

The processor 630 executes one or more programs to control the operation of the other components, to transfer data between the other components, to associate data from the various components together (preferably in a suitable data structure), to perform calculations using the data, to otherwise manipulate the data, and to present results to the customer. For example, processor 630 preferably executes one or more modules that implement methods 200, 300, and 500, such as the card usage module 110 and the reward module 130.

The input/output controller 635 interfaces to one or more user input devices, such as a keypad or keyboard 636, a pointing device, a trackball, or other wired or wireless input devices. Accordingly, the input/output controller 635 may include hardware, software, firmware, or any combination thereof, to implement one or more protocols, such as stacked protocols along with corresponding layers. Thus, the input/output controller 635 may function as a RS232 port, a USB port, an ethernet port, a parallel port, an IEEE 1394 serial port, and an IR interface. The input/output controller 635 may also support various wired, wireless, optical, and other communication standards. While the input devices may be integrated into the merchant debit machine 600 and coupled to processor 630 via the input/output controller 635, the input devices may also connect via other interfaces, such as connector 637.

The merchant debit machine 600 further includes memory 640, which may be implemented using one or more standard memory devices. The memory devices may include, for instance, RAM 641, ROM 642, or EEPROM devices, and may also include magnetic or optical storage devices, such as hard disk drives, CD-ROM drives, and DVD-ROM drives. The merchant debit machine 600 also includes a memory interface 645 coupled to an internal hard disk drive 646. The interface 645 may also be coupled to an internal drive, such as an optical disk drive, or an external drive, such as a drive coupled to the merchant debit machine 600 over a USB, IEEE 1194, or PCMCIA connection. The interface 645 may also be coupled to a removable memory, such as flash memory. The memory 120 referred to with respect to FIG. 1 may comprise the memory 640, drive 646, or both.

In one embodiment, any number of program modules are stored in the memory 640 or the drive 646, including an operating system (OS) 650, one or more program modules or components 655, and data 660. Any suitable operating system 650 may be employed. One or more of the program modules 655 may comprise a set of instructions that implement one or more of the methods 200, 300, or 500, such as the card usage module 110 and the reward module 130. Data 660 may comprise database table 400, the card usage records, the transaction records, the threshold values, and the reward data.

The network interface 665 may be provided to communicate with an external network and one or more remote servers or data stores. For example, the network interface 665 may comprise a modem that connects to an electronic fund transfer network via a leased line or conventional plain old telephone service (POTS) line. The network interface 665 may facilitate wired or wireless communication with other devices over a short distance (e.g., Bluetooth™) or nearly unlimited distances (e.g., the Internet). In the case of a wired connection, a data bus may be provided using any protocol, such as IEEE 802.3 (Ethernet), advanced technology attachment (ATA), personal computer memory card international association (PCMCIA), or USB, for example. A wireless connection may use low or high powered electromagnetic waves to transmit data using any wireless protocol, such as Bluetooth™, IEEE 802.11b (or other WiFi standards), infrared data association (IrDa), or radio frequency identification (RFID), for example.

One or more client computer systems may communicate with the merchant debit machine 600 via the network interface 665 to allow, for example, one or more merchants to send or receive data associated with their rewards program. For example, the merchant debit machine 600 may record reward data so that the merchant can review the number of rewards being offered and the nature of the rewards being offered. By way of another example, one or more of the merchants may use a client computer system to set one or more threshold values (e.g., a minimum number of debit transactions, a minimum aggregate transaction amount, or a period of time during which to reach the threshold values), the period of time after which certain transactions may expire, and the reward to offer the customer. The client computer systems may comprise general or special purpose computers or other electronic devices, such as portable electronic devices.

The merchant debit machine 600 may also include a product or reward dispenser 670. Thus, instead of having the customer take a receipt to a merchant clerk to collect the reward, the merchant debit machine 600 may dispense the reward via reward dispenser 670.

FIG. 7 is a block diagram illustrating a system 700 in which multiple merchant debit machines 710 through 730 access card usage records stored on a common storage device 120, according to one embodiment. For example, a merchant having multiple merchant locations (e.g., a chain of convenience stores) may allow transactions performed by the customer on a merchant debit machine at any of the locations count toward the reward program. Thus, the memory 120 may be centralized (or installed on one or more of the merchant debit machines 710 through 730) and each of the merchant debit machines may access the memory 120 via a network interface (e.g., network interface 665). The merchant debit machines 710 through 730 may comprise a merchant debit machine similar or identical to that described with reference to FIG. 6. In other words, the merchant debit machines 710 through 730 may comprise one or more of an ATM, POS terminal, debit POS terminal, cash register, general-purpose computer, or special-purpose computer. Thus, each of the merchant debit machines 710 through 730 may have the card usage module 110 and reward module 130 installed thereon.

FIG. 8 is a block diagram of an example system 800 in which a remote processor 810 implements a loyalty reward program. The system 800 includes one or more merchant debit machines 820 that communicate with the remote processor 810 over a communications network 830. The merchant debit machines 820 may be affiliated with a single merchant (e.g., a chain of convenience stores or restaurants) or may be affiliated with different merchants (e.g., one merchant debit machine may be affiliated with a restaurant and another merchant debit machine may be affiliated with a convenience store). To process a debit transaction received from one of the merchant debit machines 820, the remote processor 810 communicates with one or more financial institutions 840 over one or more electronic fund transfer (EFT) networks 850, such as one or more interbank networks (e.g., PLUS, Cirrus, Interac, Star, Pulse, Maestro, or Exchange) or other proprietary networks that transmit financial information and to which access is restricted. The one or more financial institutions 840 may comprise a computer system (e.g., server, storage device, and/or database) of a bank, credit union, credit card company, stock brokerage, or other institution that collects funds from the public to place in financial assets such as stocks, bonds, money market instruments, bank deposits, checking account deposits, or loans.

According to a preferred embodiment, the remote processor 810 has installed thereon one or more program modules comprising a set of instructions to implement one or more of the methods 200, 300, or 500, such as the card usage module 110 and the reward module 130. Thus, after one of the merchant debit machines 820 receive the data 140 (e.g., card data 142 and transaction data 144) associated with a debit transaction, the merchant debit machine transmits to the remote processor 810 over a communications network 830 the data 140. After the remote processor 810 receives the data 140, the remote processor 810 processes the debit transaction using one or more of the EFT networks 850. For example, if the customer requests to withdraw currency using one of the merchant debit machines 820, the remote processor 810 queries (over an appropriate EFT network) a database associated with one of the financial institutions having stored therein account numbers along with associated PINs and account balances. If the account number entered by the customer (at the merchant debit machine) matches an account number stored in the database, the PIN entered by the customer matches a PIN associated with the account number, and the transaction amount is less than or equal to the account balance associated with the account number, the withdrawal request is authorized.

After confirming that the transaction is authorized or receiving an authorization from one of the financial institutions 840, the card usage module 110, the reward module 130, or both, may be called or executed by the remote processor 810. For example, the card usage module 110 may generate and update data (e.g., transaction data) associated with customers and the reward module 130 may determine whether to reward a customer for performing one or more debit transactions on a defined set of merchant debit machines. The card usage module 110, the reward module 130, or both, may communicate with one or more of the merchant debit machines 820 via the communications network 830. For example, the card usage module 110 may notify the customer about the loyalty reward program over the communications network 830 and invite the customer to participate in the rewards program over the communications network 830. By way of another example, the reward module 130 may notify the customer of the reward over the communications network 830. The remote processor 810 may also transmit to the merchant debit machine an indication of whether the transaction was authorized or denied via the communications network 830.

The remote processor 810 may include one or more central processing units (CPUs), a graphical user interface, input/output devices, internal/external storage, such as the memory 120, and a wired and/or wireless communication network interface or adapter for communicating with the communications network 830, the EFT network 850, or both. Thus, the remote processor 810 may include an application program that accepts connections in order to service requests by sending back responses. According to one embodiment, the remote processor 810 also implements a remote currency dispense and control system that securely dispenses cash and that operates independently of electronic fund transfer (EFT) networks, further details of which are described in International Application No. PCT/US09/32492, filed Jan. 29, 2009. The memory 120 may be implemented using one or more standard memory devices, such as RAM, ROM, EEPROM, flash memory, and magnetic or optical storage devices. Any number of program modules may be stored in the memory 120, including an operating system (OS), one or more program modules or components, and data. Any suitable OS may be employed. The one or more of the program modules may comprise a set of instructions that implement one or more of the methods 200, 300, or 500, such as the card usage module 110 and the reward module 130. The data may comprise database table 400, the card usage records, the transaction records, the threshold values, and the reward data.

The remote processor 810 may service debit transactions for a single merchant or for multiple merchants. For example, the remote processor 810 may service debit transactions for a restaurant or a chain of restaurants (e.g., the merchant debit machine or machines 820 located within each restaurant are configured to communicate with the remote processor 810 to process debit transactions). Thus, a merchant having multiple merchant locations (e.g., a chain of convenience stores) may allow transactions performed by the customer on a merchant debit machine at any of the locations count toward the reward program. In other words, the customer may be rewarded for performing debit transactions at any of the merchant locations (regardless of whether the merchant locations are nearby or faraway from one another). In addition, a merchant or group of merchants may form a single reward program. For example, a group of merchants located within a shopping center may want to reward customers for performing transactions at any of the merchants in the shopping center. The remote processor 810 may also service debit transactions for a plurality of different merchants, such as one or more restaurants (or restaurant chains), stores, and gas stations. Thus, each of the different merchants may establish their own rewards program and the remote processor 810 may implement the rewards programs for the plurality of different merchants. Each of the merchant debit machines 820 may, therefore, transmit to the remote processor 810 a terminal identification (e.g., a unique terminal identification number may be assigned to each of the merchant debit machines 820) so that the remote processor 810 can determine which merchant debit machine the customer is using. The terminal identifications allow the remote processor 810 to credit transaction data to merchant reward program associated with the merchant debit machine used to perform the transaction. In other words, if the customer performs transactions at multiple merchant locations, each of which have their own rewards program, the remote processor can use the terminal identifications to differentiate the transaction data. Thus, if the customer performs ten transactions at a merchant debit machine associated with a first merchant and subsequently performs a new transaction at a merchant debit machine associated with another merchant, the transaction data associated with the new transaction will not be credited toward the rewards program associated with the first merchant. In certain embodiments, however, all transactions processed by the remote processor 810 may count towards a reward program (e.g., the remote processor 810 may be offering the rewards program and offer the reward to the customer or merchant).

The merchant debit machines 820 may comprise a merchant debit machine similar or identical to that described with reference to FIG. 6 or 7. In other words, the merchant debit machines 820 may comprise one or more of an ATM, POS terminal, debit POS terminal, cash register, general-purpose computer, or special-purpose computer. According to a preferred embodiment, the merchant debit machines 820 do not have the card usage module 110 and reward module 130 installed thereon. However in other embodiments, one or more of the merchant debit machines 810 may have the card usage module 110 and reward module 130 installed thereon or all or a portion of the card usage module 110, the reward module 130, or both, may be distributed between the merchant debit machines 820 and the remote processor 810.

The communications network 830 may comprise any suitable means of connecting one device to another for the purpose of transmitting and receiving data. Thus, the communications network 830 may comprise a network that facilitates either one or both of wired and wireless communication between electrical devices over either one or both of short distances, such as a local area network (LAN), and unlimited or nearly unlimited distances, such as the Internet. For example, the communications network 830 may comprise a public switched telephone network (PSTN), a short-range network (e.g., Ethernet and IEEE 802.11), a long-range network (e.g., WiMAX), and wide-area cellular telephone networks (e.g., 2G, 3G, and beyond 3G cellular telecommunication networks). Thus, the communications network 830 may comprise a wide area network (WAN), such as the Internet, along with the associated modems, internet service providers (ISPs), servers, gateways, switches, and other associated components. Additionally, the communications network 830 may comprise a cellular network of base stations along with the associated network and switching subsystems, public switched telephone networks (PSTN), internet protocol (IP) packet transmitting networks (e.g., GPRS core networks), servers, gateways, switches, and other associated components.

One or more client computer systems 860 may communicate with the remote processor 810 and/or one or more of the merchant debit machines 820 via the communications network 830 to allow, for example, one or more merchants to send or receive data associated with their rewards program. For example, the remote processor 810 and/or the merchant debit machines 820 may record reward data so that the merchant can review which merchant debit machines result in rewards being offered and the nature of the rewards being offered. By way of another example, one or more of the merchants may use a client computer system 860 to set one or more threshold values (e.g., a minimum number of debit transactions, a minimum aggregate transaction amount, or a period of time during which to reach the threshold values), the period of time after which certain transactions may expire, and the reward to offer the customer. The client computer systems 860 may comprise general or special purpose computers or other electronic devices, such as portable electronic devices.

FIG. 9 is a block diagram of a system 900 in which one or more financial institutions 930 implement a customer loyalty reward program, according to one embodiment. The system 900 includes one or more merchant debit machines 910 that communicate with the financial institution(s) 930 over one or more electronic fund transfer (EFT) networks 920, such as one or more interbank networks (e.g., PLUS, Cirrus, Interac, Star, Pulse, Maestro, or Exchange) or other proprietary networks that transmit financial information and to which access is restricted. The one or more financial institutions 930 may comprise any of the financial institutions described with reference to FIG. 8.

According to a preferred embodiment, the financial institution(s) 930 has installed thereon one or more program modules comprising a set of instructions to implement one or more of the methods 200, 300, or 500, such as the card usage module 110 and the reward module 130. Thus, after one of the merchant debit machines 910 receive the data 140 (e.g., card data 142 and transaction data 144) associated with a debit transaction, the merchant debit machine transmits to a financial institution 930 over the EFT network 920 the data 140. After the financial institution 930 receives the data 140, the financial institution 930 processes the debit transaction. For example, if the customer requests to withdraw currency using one of the merchant debit machines 910, the financial institution 930 queries a database (e.g., on memory 120 or on a memory associated with another financial institution over an appropriate EFT network) having stored therein account numbers along with associated PINs and account balances. If the account number entered by the customer (at the merchant debit machine) matches an account number stored in the database, the PIN entered by the customer matches a PIN associated with the account number, and the transaction amount is less than or equal to the account balance associated with the account number, the withdrawal request is authorized.

After confirming that the transaction is authorized or receiving an authorization that the transaction is authorized, the card usage module 110, the reward module 130, or both, may be called or executed by the financial institution 930. For example, the card usage module 110 may generate and update data (e.g., transaction data) associated with customers and the reward module 130 may determine whether to reward a customer for performing one or more debit transactions on a defined set of merchant debit machines. The card usage module 110, the reward module 130, or both, may communicate with one or more of the merchant debit machines 910 via the EFT network 920. For example, the card usage module 110 may notify the customer about the loyalty reward program over the EFT network 920 and invite the customer to participate in the rewards program over the EFT network 920. By way of another example, the reward module 130 may notify the customer of the reward over the EFT network 920. The financial institution 930 may also transmit to the merchant debit machine an indication of whether the transaction was authorized or denied via the EFT network 920.

The financial institution 930 may include one or more central processing units (CPUs), a graphical user interface, input/output devices, internal/external storage, such as the memory 120, and a wired and/or wireless communication network interface or adapter for communicating with the EFT network 850. The memory 120 may be implemented using one or more standard memory devices, such as RAM, ROM, EEPROM, and magnetic or optical storage devices. Any number of program modules may be stored in the memory 120, including an operating system (OS), one or more program modules or components, and data. The one or more of the program modules may comprise a set of instructions that implement one or more of the methods 200, 300, or 500, such as the card usage module 110 and the reward module 130. The data may comprise database table 400, the card usage records, the transaction records, the threshold values, the reward data, and the account numbers along with associated PINs and account balances to authorize debit transactions.

The financial institution 930 may service debit transactions for a single merchant or for multiple merchants, as described with reference to FIG. 8. Thus, a merchant having multiple merchant locations (e.g., a chain of convenience stores) may allow transactions performed by the customer on a merchant debit machine at any of the locations count toward the reward program. In addition, the financial institution 930 may also service debit transactions for a plurality of different merchants, such as one or more restaurants (or restaurant chains), stores, and gas stations. Thus, each of the different merchants may establish their own rewards program and the financial institution 930 may implement the rewards programs for the plurality of different merchants. Each of the merchant debit machines 910 may, therefore, transmit to the financial institution 930 a terminal identification (e.g., a unique terminal identification number may be assigned to each of the merchant debit machines 910) so that the financial institution can determine which merchant debit machine the customer is using.

The merchant debit machines 910 may comprise a merchant debit machine similar or identical to that described with reference to FIG. 6, 7, or 8. In other words, the merchant debit machines 910 may comprise one or more of an ATM, POS terminal, debit POS terminal, cash register, general-purpose computer, or special-purpose computer. According to a preferred embodiment, the merchant debit machines 910 do not have the card usage module 110 and reward module 130 installed thereon. However in other embodiments, one or more of the merchant debit machines 910 may have the card usage module 110 and reward module 130 installed thereon or all or a portion of the card usage module 110, the reward module 130, or both, may be distributed between the merchant debit machines 910 and the financial institution 930.

The methods and systems for rewarding a customer for performing one or more debit transactions may be implemented in and/or by any suitable hardware, software, firmware, or combination thereof. Accordingly, as used herein, a component or module may comprise hardware, software, and/or firmware (e.g., self-contained hardware or software components that interact with a larger system).

The methods and systems may exist as one or more software or firmware programs comprised of program instructions in source code, object code, executable code or other formats. A software module or component may include any type of computer instruction or computer executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network. Following the teachings herein, a suitable service provider, such as Smart Processing Solutions, Inc. of Toronto, ON (Canada), now NRT Technology Corp., may write the code.

Embodiments may include various steps, which may be embodied in machine-executable instructions to be executed by a general-purpose or special-purpose processor (or other electronic device). Alternatively, the steps may be performed by hardware components that include specific logic for performing the steps or by a combination of hardware, software, and/or firmware. A result or output from any step, such as a confirmation that the step has or has not been completed or an output value from the step, may be stored, displayed, printed, and/or transmitted over a wired or wireless network. For example, the authorization and/or denial may be stored, displayed, or transmitted over a network.

Embodiments may also be provided as a computer program product including a machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be via CD-ROM or via Internet download.

It will be obvious to those having skill in the art that many changes may be made to the details of the above-described embodiments without departing from the underlying principles of the invention. For example, although embodiments have been described with reference to debit transactions, the systems and methods described herein are equally applicable to credit transactions (e.g., a transaction that creates a loan obligation). The scope of the present invention should, therefore, be determined only by the following claims.

1. A method of rewarding a customer for performing multiple debit transactions, comprising:
receiving data associated with a discrete one of the multiple debit transactions performed by the customer using a merchant debit machine in a defined set of merchant debit machines, the data including card data and transaction data;
determining whether a card usage record corresponding to the card data is stored in a memory;
if a card usage record corresponding to the card data is not stored in the memory, generating a card usage record corresponding to the card data and storing the card usage record in the memory, the card usage record having stored therein the card data and the transaction data but not personally identifiable information associated with the customer;
if a card usage record corresponding to the card data is stored in the memory, updating the card usage record so that the card usage record reflects the transaction data associated with the discrete one of the multiple debit transactions and transaction data previously stored in the card usage record;
determining whether the card usage record has stored therein transaction data that meets or exceeds a predetermined threshold value; and
if the card usage record has stored therein transaction data that meets or exceeds the predetermined threshold value, providing the customer with a reward, thereby rewarding the customer for performing multiple debit transactions on a defined set of merchant debit machines without having the customer provide personally identifiable information.

2. The method of claim 1, wherein the defined set of merchant debit machines consists of a single merchant debit machine.

3. The method of claim 1, wherein at least one of the merchant debit machines in the defined set comprises an automated teller machine.

4. The method of claim 1, wherein at least one of the merchant debit machines in the defined set comprises a debit point-of-sale terminal.

5. The method of claim 1, wherein the step of receiving data associated with the discrete one of the multiple debit transactions comprises receiving, at a first merchant debit machine in the defined set, the data and wherein the first merchant debit machine performs the steps of determining whether a card usage record corresponding to the card data is stored in a memory and determining whether the card usage record has stored therein transaction data that exceeds a predetermined threshold value.

6. The method of claim 1, wherein the step of receiving data associated with the discrete one of the multiple debit transactions comprises receiving, at a remote processor over a communications network, the data and wherein the remote processor performs the steps of determining whether a card usage record corresponding to the card data is stored in a memory and determining whether the card usage record has stored therein transaction data that exceeds a predetermined threshold value.

7. The method of claim 1, wherein the predetermined threshold value comprises a minimum number of debit transactions performed within a predefined period of time.

8. The method of claim 1, wherein the predetermined threshold value comprises a minimum total transaction amount performed within a predefined period of time.

9. The method of claim 1, further comprising:
updating the card usage record to remove transaction data associated with debit transactions performed before a predetermined date.

10. The method of claim 1, further comprising:
after determining that a card usage record corresponding to the debit card data is not stored in the memory, presenting a prompt to the customer requesting whether the customer would like to opt-out of having the card usage record generated.

11. The method of claim 1, further comprising:
presenting a prompt to a merchant requesting from the merchant a submission of the predetermined threshold value; and
presenting a prompt to the merchant requesting from the merchant a submission of the reward to provide the customer if the card usage record has stored therein transaction data that exceeds the predetermined threshold value.

12. The method of claim 1, wherein the reward comprises one or more goods, services, or both, offered for sale by a merchant associated with the defined set of merchant debit machines.

13. The method of claim 1, wherein the step of providing the customer with a reward comprises printing on a receipt associated with the discrete transaction an indication of the reward along with instructions that the reward can be collected from a merchant-clerk.

14. A machine-readable medium on which are stored computer program instructions for rewarding a customer for performing multiple debit transactions according to claim 1.

15. A system for rewarding a customer for performing multiple debit transactions, comprising:
a set of merchant debit machines that receive data associated with a discrete one of the multiple debit transactions performed by the customer, the data including card data and transaction data;
a card usage module that (1) determines whether a card usage record corresponding to the card data is stored in a memory, (2) generates a card usage record having stored therein the card data and the transaction data but not personally identifiable information associated with the customer if a card usage record corresponding to the card data is not stored in the memory, and (3) updates the card usage record so that the card usage record reflects the transaction data associated with the discrete transaction and transaction data previously stored in the card usage record if a card usage record corresponding to the card data is stored in the memory; and
a reward module that determines whether the card usage record has stored therein transaction data that meets or exceeds a predetermined threshold value and, if so, provides the customer with an indication of a reward, thereby rewarding the customer for performing multiple debit transactions on a set of merchant debit machines without having the customer provide personally identifiable information.

16. The system of claim 15 wherein at least one of the merchant debit machines in the set comprises an automated teller machine.

17. The system of claim 15 wherein the card usage module and the reward module are installed on one of the merchant debit machines in the set of merchant debit machines.

18. The system of claim 15 wherein the card usage module and the reward module are installed on a remote processor and further comprising:
a first communication component installed on at least one of the merchant debit machines, the first communication component transmitting to the remote processor the data associated with the discrete one of the multiple debit transactions; and
a second communication component installed on the remote processor, the second communication component receiving the data associated with the discrete one of the multiple debit transactions.

19. The system of claim 15, wherein the predetermined threshold value comprises a minimum number of debit transactions.

20. The system of claim 15, wherein the predetermined threshold value comprises a minimum total transaction amount.

21. The system of claim 15, wherein the card usage module updates the card usage record to remove transaction data associated with debit transactions performed before a predetermined date.

22. The system of claim 15, wherein the card usage module causes a display to present a prompt to the customer requesting whether the customer would like to opt-out of having the card usage record generated.

23. A system for rewarding a customer for performing multiple debit transactions, comprising:
a card reader for reading card data stored on a card;
a display that can be viewed by a customer;
an input device for receiving from the customer transaction data including a transaction amount;
a memory for storing a plurality of card usage records, each card usage record including a card-number field for storing card data, a total-number-of-transactions field for storing a total number of transactions performed using the card data with the system, and an aggregate-transaction-amount field for storing an aggregate transaction amount for transactions performed using the card data with the system, but not personally identifiable information associated with the customer; and
a processor coupled to the card reader, the display, the input device, and the memory, the processor configured to:
determine whether a card usage record corresponding to the card data read by the card reader is stored in the memory;
if a card usage record corresponding to the card data is not stored in the memory, generate a card usage record corresponding to the card data and store the card usage record in the memory, the card usage record having stored in a card-number field the card data, having stored in a total-number-of-transactions field one transaction, and having stored in an aggregate-transaction-amount field the transaction amount, but not having stored therein personally identifiable information associated with the customer;
if a card usage record corresponding to the card data is stored in the memory, increment a total number of transactions stored in a total-number-of-transactions field and add the transaction amount to an aggregate transaction amount stored in an aggregate-transaction-amount field;
determine whether the card usage record has stored therein a total number of transactions that meets or exceeds a predetermined minimum number of transactions, an aggregate transaction amount that meets or exceeds a minimum aggregate transaction amount, or both; and
if so, cause the display to provide the customer with an indication of a reward the customer has received, thereby rewarding the customer for performing transactions on the merchant debit card machine without having the customer provide personally identifiable information.

24. The system of claim 23, further comprising:
a bill dispenser for dispensing transaction amount; and
a printer for printing on a receipt an indication of the reward along with instructions that the reward can be collected from a merchant-clerk.

25. The system of claim 23, wherein the system comprises an automated teller machine.
